(19) United States
(12) Patent Application Publication
(10) Pub. No.: US 2006/0172166 A1
(43) Pub. Date: Aug. 3, 2006

(54) Solid-oxide fuel cell and method for producing the same

(75) Inventor: Thomas Hoefler, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: BAYERISCHE MOTOREN WERKE AKTIENGESELLSCHAFT, MUENCHEN (DE)

(21) Appl. No.: 11/363,319

(22) Filed: Feb. 28, 2006

Related U.S. Application Data
(63) Continuation of application No. PCT/EP04/51501, filed on Jul. 15, 2004.

(30) Foreign Application Priority Data
Aug. 28, 2003 (DE) 103 39 613.6

(51) Int. Cl. H01M 8/12

(52) U.S. Cl. 429/30; 429/41; 427/115

(57) ABSTRACT

A solid oxide fuel cell with an electrolyte layer on a porous primer having an electrolyte material. For the electrolyte layer, nanoparticles are preferably used. As a result of sintering at a relatively low temperature, the nanoparticles lead to a thin gas-tight electrolyte layer.

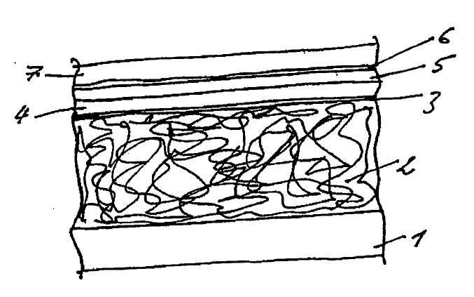

### CROSS-REFERENCE TO RELATED APPLICATIONS

This application is a continuation of International Patent Application No. PCT/EP2004/051501, filed Jul. 15, 2004, designating the United States of America, and published in German as WO 2005/024990 A1, the entire disclosure of which is incorporated herein by reference. Priority is claimed based on Federal Republic of Germany patent Application No. DE 103 39 613.6, filed Aug. 28, 2003.

### FIELD OF THE INVENTION

The invention relates to a solid oxide fuel cell as well as to a method of producing the same.

### BACKGROUND OF THE INVENTION

In addition to the quality of the anode and the cathode, the power density of solid oxide fuel cells (SOFCs) depends mainly on the material and the thickness of the electrolyte as well as the operating temperature. Particularly, when the solid oxide fuel cell is used in automobiles, operating temperatures of less than 800° C. are preferred in order to be able to use metallic materials, such as steel, for the bipolar plates and other parts of the fuel cell. At higher temperatures, steel is subject to considerable corrosion.

The electrolyte layer, which is produced from a high-melting metal oxide, particularly yttrium-stabilized zirconium dioxide, one the one hand, has to be absolutely gastight in order to separate the anode space from the cathode space; on the other hand, it should be as thin as possible in order to ensure a fast transport of the oxygen ions from the cathode to the anode.

However, such thin gastight electrolyte layers can be implemented only by means of sintering techniques. For this purpose, high sintering temperatures of approximately 1,400° C. and long sintering times are required.

The sintering of the electrolyte layer takes place on the electrode layer which had been applied to the carrying structure, the carrying structure being a porous layer, by way of which—in the case of an anode-carried SOFC—the fuel is supplied. Therefore, the carrying structure must consist of a material which withstands the high sintering temperature. Although this applies to a carrying structure made of an anode material consisting of a mixture of yttrium-stabilized ZrO₂ and Ni oxide, it does not apply to a carrying structure or cathode material made of metal. However, specifically for uses in automobiles, solid oxide fuel cells are preferred in the case of which the electrode layer is provided on a metal carrying structure, which results in a faster heatability, a higher redox resistance and saves costs. In addition, a simpler joining technique can be used because, for example, the metallic carrying structure can be tightly connected by laser welding with its outer circumference with the bipolar plate made of metal.

Since, because of the high sintering temperature, solid oxide fuel cells with a metallic carrying structure are difficult to produce by sintering, the electrolyte layer is usually applied to a metallic carrying structure by thermal spraying. Because the density of an electrolyte layer produced by thermal spraying is lower than that of an electrolyte layer produced by sintering, the electrolyte layer should have a thicker construction when it is deposited by thermal spraying. This means that, for the electrolyte layer of a solid oxide fuel cell with a metallic carrying structure to be gastight, thickness layers of up to 60 μm are required, whereby the power density of the solid oxide fuel cell at 800° C. and 0.7 V empirically is limited to maximally approximately 0.4 W/cm². This is disadvantageous for uses in automobiles where fuel cells are required which are as compact as possible and have a high power density.

### SUMMARY OF THE INVENTION

One object of the invention is to provide a solid oxide fuel cell of a high power density which has a thin electrolyte layer which can be produced without high temperature-caused stress, so that metallic carrying structures can be used.

Other objects, advantages and novel features of the present invention will become apparent from the following detailed description of the invention when considered in conjunction with the accompanying drawings for example.

### BRIEF DESCRIPTION OF THE DRAWING

The FIGURE shows a cross-sectional view of a cell in accordance with an embodiment of the present invention.

### DETAILED DESCRIPTION

This object is achieved by a solid oxide fuel cell comprising at least one individual cell having a carrying structure and a layer arrangement, said layer arrangement having a gastight electrolyte layer between two electrode layers which form an anode and a cathode, the electrolyte layer being applied to a porous primer, said porous primer including electrolyte material, wherein the electrolyte layer is preferably formed of nanoparticles have a particle size no larger than 300 nm. In one embodiment, the layer arrangement may consist of the gastight electrolyte layer between two electrode layers, similarly, the porous primer may consist of electrolyte material.

According to the invention, the electrolyte layer is applied to a porous primer, which also includes electrolyte material; that is, a graduated asymmetrical construction of the electrolyte layer between the two electrodes is suggested.

Therefore, the porous primer with the electrolyte material may be first applied, for example, to the anode as the electrode layer. A thermal spraying method or a sintering method, for example, can be used for this purpose, which can be carried out at a low temperature of below 1,300° C. because a high density of the primer is not important. The primer may, for example, have a thickness of from 1 μm to 30 μm. The diameter of the pores of the primer should be smaller than 1 μm, preferably smaller than 300 nm.

According to the invention, the actual electrolyte layers may be produced of nanoparticles; that is, particles of a particle size of maximally 300 nm, preferably smaller than 100 nm. The electrode layers have a high porosity. The primer therefore essentially serves to prevent the small nanoparticles from penetrating into the comparatively large pores of the electrode layer.

The nanoparticles can be sintered at a low temperature of, for example, 1,100° C. and below. This means that, during a corresponding sintering time, a very thin gastight electrolyte layer can be produced from the nanoparticles. As a result, high power densities of above 1 W/cm² can be obtained at 800° C. and 0.7 V by means of the solid oxide fuel cell according to the invention.

In addition, as a result of the low sintering temperature of the nanoparticles, a metallic carrying structure can be used; that is, a solid oxide fuel cell can be produced at a low operating temperature of, for example, from 500° C. to 800° C. Furthermore, the thin electrolyte layer permits a faster starting time because the fuel cell already generates power and heat at low temperatures.

Also, by means of the graduated construction of the electrolyte material—i.e., the porous primer—an enlargement of the interphase between the electrolyte material and the electrode material is achieved, so that more active centers are available at which electrochemical conversions can take place, which, in turn, leads to an increase of the power density.

The production costs are reduced because the electrolyte material applied as the primer may be applied in a porous manner and thus by thermal coating at a higher application rate. Alternatively the electrolyte material may be sintered within shorter time periods than gastight layers.

The electrolyte material may be any metallic oxide which is suitable for SOFCs and conducts oxygen ions, such as stabilized zirconium oxide (ZrO₂) or doped ceria. Preferably, yttrium-stabilized zirconium oxide or zirconium oxide stabilized by means of calcium oxide, scandium oxide or magnesium oxide is used.

Electrolyte material is commercially available in nanoparticle size. Although the particle size of the electrolyte material may be up to 300 nm, an electrolyte material of a particle size of maximally 100 nm is preferably used.

In order to achieve a high power density, the layer thickness of the electrolyte layer should be not more than 20 μm, particularly not more than 10 μm.

The solid oxide fuel cell according to the invention preferably has a metal or a metal-ceramic material as the carrying structure. The carrying structure may be formed of threads, chips or other particles made of metal or of a metal-ceramic material. It may consist, for example, of a knitted structure, a braiding, a non-woven or a fine non-woven made of metal or a metal-ceramic material. In the case of a wide-meshed carrying structure, such as a knitted structure, a cover layer may be provided between the carrying structure and the adjoining electrode, in order to be able to apply the electrode layer. In one embodiment, the carrying structure may consist of a metal or a metal-ceramic material.

For producing the fuel cell according to the invention, an electrode layer (anode or cathode) is applied to the carrying structure which preferably includes metal or of a metal-ceramic material. The electrode layer may be applied by thermal spraying. Plasma spraying or flame spraying, for example, can be used as the thermal spraying method. However, the electrode layer can also be produced by a sintering method. When a metallic carrying structure is used in this case, at a sintering temperature of below 1,300° C. and a sintering duration of less than 4 h, the sintering should preferably take place in an inert atmosphere.

After the electrode layer has been applied to the carrying structure, electrolyte material is applied as the primer to the electrode layer. The application of the electrolyte material for forming the primer may take place by thermal spraying, thus, for example, by plasma or flame spraying or by the application of the green material and subsequent sintering. Since the primer does not have to be gastight, conditions, particularly a sintering temperature of below 1,300° C., may be used during the sintering of the primer which are similar to those used during the sintering of the electrode layer on the carrying structure.

The electrode layer and the primer may also be sintered onto the carrying structure in a single step by using a two-layer foil having an electrode material layer and an electrolyte material layer.

The gastight electrolyte layer is then formed on the primer. For this purpose, electrolyte material in the form of a powder of nanoparticles, which sinter at a low temperature and have a particle size of not more than 300 nm, particularly not more than 100 nm, is then applied to the primer.

Instead of a powder, preliminary stages of the nanoparticles, such as salts or organo-metallic compounds, can also be applied to the primer, from which the nanoparticles are formed on the primer at a higher temperature. In this case, particularly also so-called “sol-gel” materials, that is, organo-metallic polymers, were found to be suitable.

The application of the nanoparticles to the primer can take place by electrophoresis, infiltration, doctoring, printing and/or spraying.

For the electrophoresis, the composite of the carrying structure, the electrode layer and the primer can be placed, for example, in a chamber, in which the nanoparticles or their preliminary stage are dispersed in an electrically charged form. The metallic carrying structure can then be used as an electrode, for example, as a cathode, so that, when the nanoparticles or their preliminary stages are positively charged, the particles dispersed on the side of the primer in the bath are deposited on the primer. The charging of the nanoparticles can take place, for example, by way of the pH-value or by way of charged surface-active agents.

During the infiltration, the nanoparticles dispersed in a liquid can be deposited on the primer as in the case of a filter. Under pressure, the liquid can be pressed into the composite of the carrying structure, the electrode layer and the primer or the liquid can be sucked through.

Instead of using electrophoresis or infiltration, the layer of nanoparticles or their preliminary stages can also be pulled onto the primer by doctoring, or can be applied by a printing method, such as stamp printing or screen printing, or by being sprayed on. The application methods, as well as the materials, can be used in any combination.

The applied nanoparticle layer is then sintered to the electrolyte layer. The sintering can follow the application of the nanoparticle layer. However, it is also conceivable to first apply the second electrode layer and to then sinter the latter jointly with the nanoparticle layer. This means that the sintering of the two electrode layers, the primer and the electrolyte layer can take place individually after each process step, or several and possibly all layers can be sintered jointly, possibly when the operation of the solid oxide fuel cell is started.

Like the first electrode layer (anode or cathode), the second electrode layer (cathode or anode) can be applied by thermal spraying or by sintering. For the sintering, the material for the two electrodes can be applied, for example, as a foil, by doctoring, by printing techniques or by spraying.

In the following, an embodiment of an individual cell of the solid oxide fuel cell according to the invention will be explained in detail by means of an example, whose single FIGURE is a cross-sectional view of an individual cell.

Accordingly, a carrying structure 2 with a knitted or woven structure, for example, made of steel threads, is arranged on a bipolar plate 1, for example, made of steel. A porous cover layer 3, on which a layer arrangement is situated, is applied to the wide-mesh knitted structure, which layer arrangement includes the anode layer 4, the primer 5, the electrolyte layer 6 as well as the cathode layer 7.

The primer 5 and the electrolyte layer 6 may consist, for example, of yttrium-stabilized zirconium oxide. The anode layer 4 may consist, for example, of anode material, thus a mixture of nickel metal or nickel oxide and yttrium-stabilized zirconium oxide. The cathode layer 7 may, for example, be formed by a perovskitic oxide, such as lanthanum strontium manganite.

The fuel gas is supplied to the anode layer 4 by way of the carrying structure 2 while the cathode layer 7 is brought in contact with atmospheric oxygen. By arranging several such individual cells consecutively, an arbitrary stack of individual cells can be built up which will then, as a whole, form the core area of the fuel cell.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A solid oxide fuel cell comprising:
at least one individual cell having a carrying structure and a layer arrangement, said layer arrangement having a gastight electrolyte layer between two electrode layers which form an anode and a cathode, the electrolyte layer being applied to a porous primer, said porous primer including electrolyte material, wherein the electrolyte layer is formed of nanoparticles have a particle size no larger than 300 nm.

2. A solid oxide fuel cell according to claim 1, wherein the pores of the primer have a diameter of less than 1 μm.

3. A solid oxide fuel cell according to claim 1, wherein the pores of the primer have a diameter of less than 300 nm.

4. A solid oxide fuel cell according to claim 1, wherein the primer has a layer thickness of at least 1 μm and no more than 30 μm.

5. A solid oxide fuel cell according to claim 1, wherein the electrolyte layer has a layer thickness of no more than 20 μm.

6. A solid oxide fuel cell according to claim 1, wherein the carrying structure includes a metal or a metal-ceramic material.

7. A method of producing the solid oxide fuel cell of claim 1,
wherein first the first electrode layer and the primer, then the electrolyte layer and finally the second electrode layer are applied to the carrying structure, the electrolyte layer being formed of electrolyte material having particles with a particle size less than 300 nm, and being sintered after application to the primer.

8. A method according to claim 7, wherein the electrolyte material particles are applied to the primer by electrophoresis, infiltration, doctoring, printing or spraying or a combination of the foregoing.

9. A method according to claim 7, wherein the electrode layer and the primer are sintered onto the carrying structure in one step by with a two-layer foil, said two-layer foil including an electrode material layer and an electrolyte material layer.

10. A method according to claim 7, wherein the electrolyte layer is sintered and the sintering takes place during sintering one or both electrode layers or when sintering the primer or when starting the operation of the fuel cell or during a combination of the foregoing.
